(19) United States
(12) Patent Application Publication
(10) Pub. No.: US 2003/0137850 A1
(43) Pub. Date: Jul. 24, 2003

(54) LIGHT DEVICE FOR BICYCLES

(76) Inventors: Shu-Jang Liaw, Ta Li City (TW); Ti-Shuen Liaw, Ta-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,337

(22) Filed: Jan. 23, 2002

(51) Int. Cl. F21V 33/00

(52) U.S. Cl. 362/474; 362/191; 362/116

(57) ABSTRACT

A light device for bicycles includes a base having an engaging port on a first end thereof and a protrusion extending from a top surface on a second end of the base. A light assembly is rotatably connected to the top surface of the base and a flexible band has an end secured on the engaging port of the base and the other end of the flexible band is engaged with the protrusion. The base is secured on the bicycle fame by the flexible band.

### FIELD OF THE INVENTION

The present invention relates to a light device for bicycles and the device is easily connected to bicycle frame and can be rotatable.

### BACKGROUND OF THE INVENTION

A conventional light device for bicycles is shown in FIG. 1 and generally includes a casing 10 with a bulb (not shown) received therein. A recess 11 is defined in a side of the casing 10 so as to receive an engaging member 13 on a ring 12. The ring 12 mounted to the bicycle frame and secured by a screw 120. However, the size of the ring 12 is fixed so that if the bicycle frame is smaller than the inner diameter the ring 12, one or two pads 14, 14′ are used to fill the gap between the ring 12 and the bicycle frame. This is not convenient for the users to connect the light device from one bicycle frame to another.

### SUMMARY OF THE INVENTION

In accordance with one aspect of the present invention, there is provided a light device for bicycles and the device comprises a base having an engaging port on a first end thereof and a protrusion extends from a top surface on a second end of the base. A light assembly is rotatably connected to the top surface of the base. A flexible band has an end secured on the engaging port and the other end of the flexible band is engaged with the protrusion with the bicycle frame located between the flexible band and the base.

The primary object of the present invention is to provide a light device for bicycles wherein the light device can be easily attached on the bicycle frame by a flexible band.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional bicycle light device;

FIG. 2 is an exploded view to show the bicycle light device of the present invention;

FIG. 3 is a perspective view to show the bicycle light device of the present invention;

FIG. 4 is a perspective view to show the bicycle light device of the present invention attached to a handlebar;

FIG. 5 is a top view to show the bicycle light device of the present invention;

FIG. 6 is a top view to show that the bicycle light device of the present invention is rotated an angle;

FIG. 7 is a perspective view to show the bicycle light device of the present invention is connected to a bicycle helmet;

FIG. 8 is a cross sectional view to show the bicycle light device of the present invention is attached to a bicycle frame by the flexible band;

FIG. 9 is a side view to show the light device is pivoted upward;

FIG. 10 shows that the bicycle light device of the present invention is clapped on a pocket of a user.

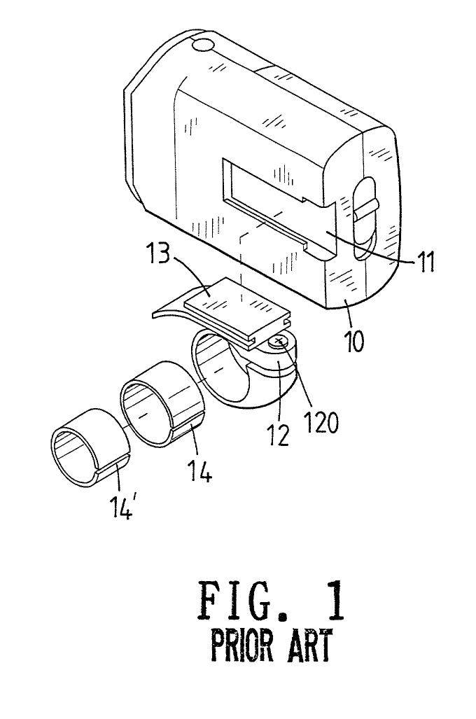

### DETAILED DESCRIPTION OF THE PREFERRED EMBODIMENT

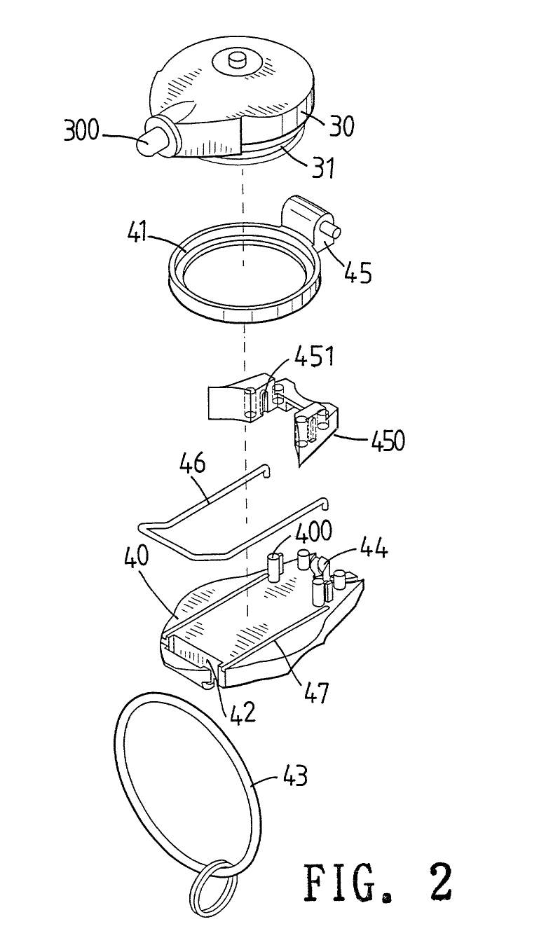

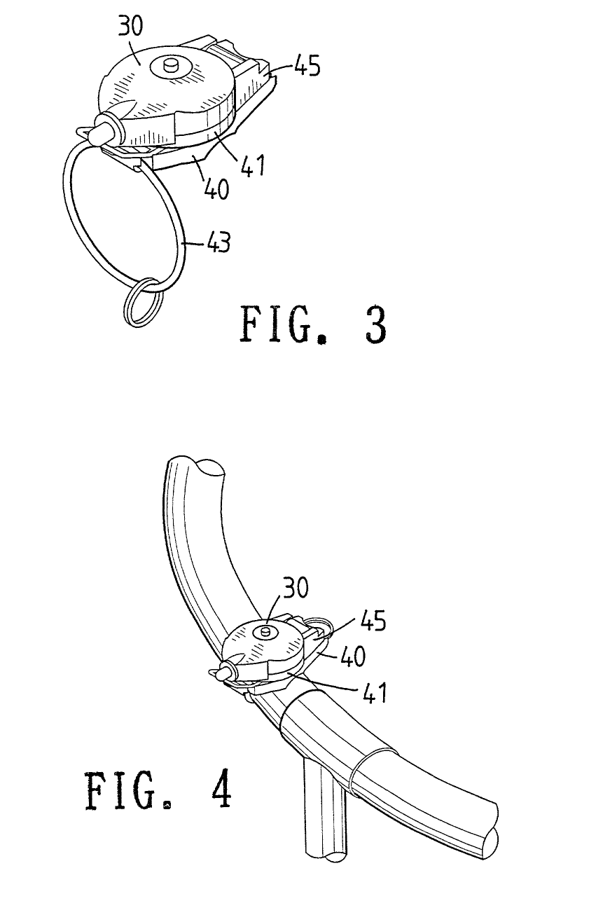

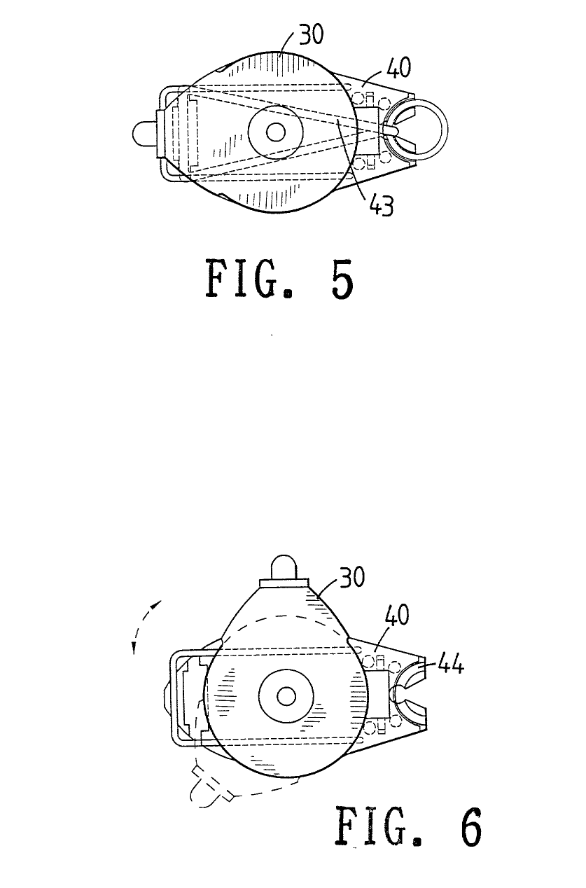

Referring to FIGS. 2, 3, 4 and 8, the light device of the present invention comprises a base 40 having an engaging port 42 on a first end thereof and a protrusion 44 extends from a top surface on a second end of the base 40. Two pairs of rods 400 extend from the top surface on the second end of the base 40 so as to engage with a support frame 450. Two parallel grooves 47 are defined in the top surface of the base 40 and two ends of a U-shaped spring 46 are inserted in the two grooves 47 so that two legs of the U-shaped spring 46 are engaged with the two grooves 47.

A ring member 41 has a tongue 45 extending radially outward therefrom and two shafts extend from two opposite ends of the tongue 45. The two shafts of the tongue 45 are pivotally engaged with two notches 451 in the support frame 450. A light assembly 30 has a bulb 300 connected thereto and an engaging ring 31 which is rotatably connected to ring member 41.

A flexible band 43 has an end secured on the engaging port 42 and the other end of the flexible band 43 is connected to a ring which is engaged with the protrusion 44.

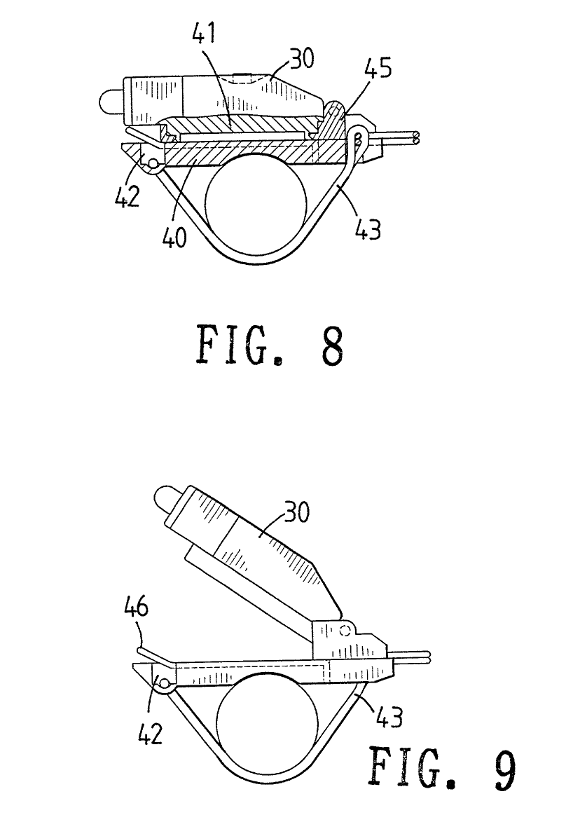

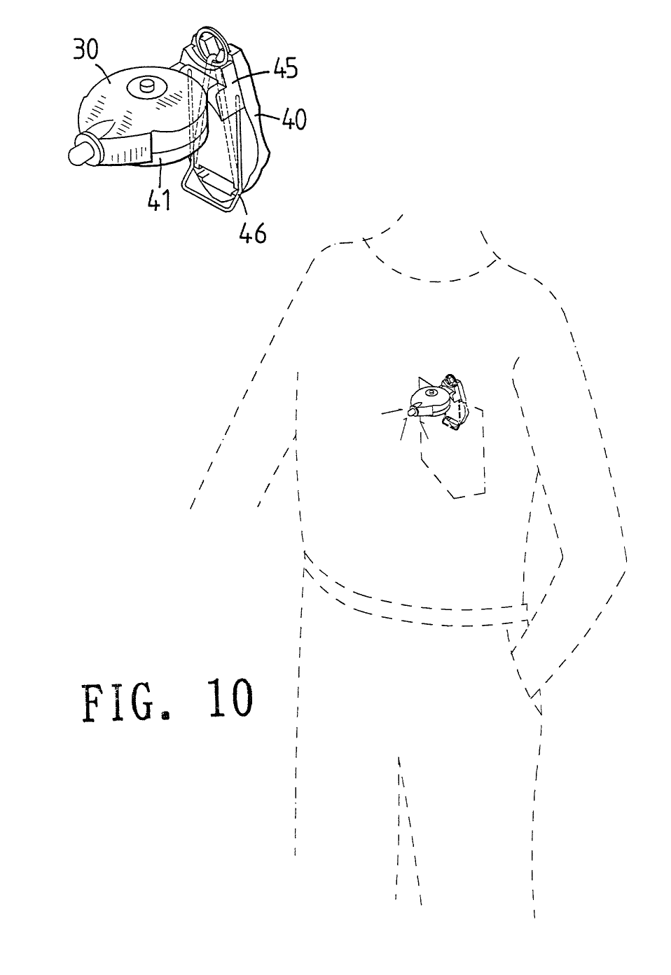

The light device of the present invention is easily secured on the bicycle frame by pulling the flexible band 43 over the bicycle frame such as a handlebar and then being engaged with the protrusion 44 as shown in FIGS. 4 and 8. The flexible band 43 allows the light device 30 to be connected to any size of the bicycle frames. The light assembly 30 can be pivoted upward as shown in FIG. 9 and the light assembly 30 can also be rotated as shown in FIG. 6 such that the light device of the present invention can be used on almost any position of the bicycle and the bulb 300 can be adjusted to desired direction.

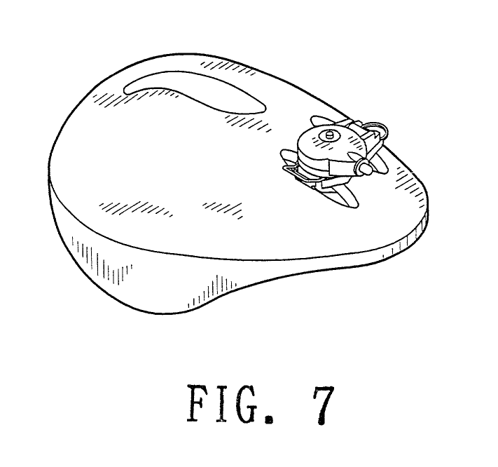

As shown in FIG. 7, the light device can be attached on a bicycle helmet. The light device can also be clamped on a packet as shown 10 by using the U-shaped spring 46.

While we have shown and described the embodiment in accordance with the present invention, it should be clear to those skilled in the art that further embodiments may be made without departing from the scope of the present invention.

What is claimed is:

1. A light device for bicycles, comprising:
a base having an engaging port on a first end thereof and a protrusion extending from a top surface on a second end of the base;
a light assembly rotatably connected to the top surface of the base, and
a flexible band having an end secured on the engaging port and the other end of the flexible band engaged with the protrusion.

2. The device as claimed in claim further comprising a ring member connected to the top surface of the base and a light assembly is rotatably engaged with the ring member.

3. The device as claimed in claim 2, wherein the ring member has a tongue extending radially outward therefrom and two shafts extend from two opposite ends of the tongue, a support frame connected on the top surface at the second end of the base 40 and the two shafts of the tongue pivotally connected to the support frame.

4. The device as claimed in claim 3 further comprising a U-shaped spring which has two ends connected to the top surface of the base.

5. The device as claimed in claim 4 further comprising two parallel grooves defined in the top surface of the base and two legs of the U-shaped spring engaged with the two grooves.
